(19) United States
(12) Patent Application Publication
(10) Pub. No.: US 2025/0361832 A1
(43) Pub. Date: Nov. 27, 2025

(54) COMBUSTION SYSTEM USING AMMONIA AS FUEL

(71) Applicant: IHI Corporation, Tokyo (JP)

(72) Inventors: Soichiro KATO, Tokyo (JP); Shintaro ITO, Tokyo (JP)

(73) Assignee: IHI Corporation, Tokyo (JP)

(21) Appl. No.: 19/280,853

(22) Filed: Jul. 25, 2025

Related U.S. Application Data
(63) Continuation of application No. PCT/JP2023/034734, filed on Sep. 25, 2023.

(30) Foreign Application Priority Data
Feb. 6, 2023 (JP) 2023-016262

(51) Int. Cl. F02C 3/22; F02C 6/18; F02C 7/141; F02C 7/224

(52) U.S. Cl. CPC F02C 3/22; F02C 6/18; F02C 7/141; F02C 7/224; F05D 2220/72; F05D 2240/35; F05D 2260/213

(57) ABSTRACT

A combustion system includes a combustor, a reheating burner that is in fluid communication with the combustor and that heats exhaust gas supplied from the combustor, heat utilization equipment that is in fluid communication with the reheating burner and that uses heat of the exhaust gas, a re-circulation flow path that supplies a part of the exhaust gas used in the heat utilization equipment to the combustor, and a first heat exchanger that is arranged on the re-circulation flow path, the first heat exchanger exchanging heat between the exhaust gas and ammonia, the first heat exchanger supplying vaporized ammonia to the reheating burner and supplying cooled exhaust gas to the combustor.

### CROSS REFERENCE TO RELATED APPLICATIONS

This application is a continuation application of International Application No. PCT/JP2023/034734, filed on Sep. 25, 2023, which claims priority to Japanese Patent Application No. 2023-016262 filed on Feb. 6, 2023, the entire contents of which are incorporated herein by reference.

### BACKGROUND ART

### Technical Field

The present disclosure relates to a combustion system using ammonia as fuel.

For example, a combustion system including a gas turbine, a steam turbine, or the like includes a reheating burner in some cases (see, for example, Patent Literatures 1 and 2). The reheating burner heats exhaust gas supplied from a combustor. The heated exhaust gas is used in, for example, heat utilization equipment such as a heat recovery steam generator. With such a configuration, when the temperature of the exhaust gas supplied from the combustor is not high enough for use in the heat utilization equipment, the exhaust gas can be heated up to a sufficient temperature.

### CITATION LIST

### Patent Literature

Patent Literature 1: JP 2002-70581 A
Patent Literature 2: JP 2004-225966 A

### SUMMARY

### Technical Problem

Ammonia is known as fuel that does not release CO₂. Accordingly, it is conceivable that ammonia is used as fuel also in the combustion system including a reheating burner as described above. Furthermore, ammonia is known to have flame retardancy. Accordingly, when ammonia is used as fuel, it is desired to improve flammability of ammonia to improve combustion efficiency.

The present disclosure has an object to provide a combustion system using ammonia as fuel, with which combustion efficiency can be improved.

### Solution to Problem

According to an aspect of the present disclosure, there is provided a combustion system using ammonia as fuel, the combustion system including a combustor, a reheating burner that is in fluid communication with the combustor and that heats exhaust gas supplied from the combustor, heat utilization equipment that is in fluid communication with the reheating burner and that uses heat of the exhaust gas, a re-circulation flow path that supplies a part of the exhaust gas used in the heat utilization equipment to the combustor, and a first heat exchanger arranged on the re-circulation flow path, the first heat exchanger exchanging heat between the exhaust gas and ammonia, the first heat exchanger supplying vaporized ammonia to the reheating burner and supplying cooled exhaust gas to the combustor.

The combustion system may further include a second heat exchanger arranged on the re-circulation flow path, the second heat exchanger exchanging heat between the exhaust gas and liquid ammonia, the second heat exchanger supplying a part of heated ammonia to the combustor and supplying remaining part of the heated ammonia to the first heat exchanger. The first heat exchanger may exchange heat between the exhaust gas and the heated ammonia supplied from the second heat exchanger.

The second heat exchanger may supply the part of the heated ammonia in a liquid state to the combustor.

The second heat exchanger may supply the part of the heated ammonia in a gas state to the combustor.

The combustion system may further include an injector that directly injects liquid ammonia to the exhaust gas flowing through the re-circulation flow path.

The combustion system may further include a denitrification equipment that reduces a nitrogen oxide in the exhaust gas. The first heat exchanger may supply a part of the vaporized ammonia to the denitrification equipment.

### Effects

According to the present disclosure, combustion efficiency can be improved in the combustion system using ammonia as fuel.

### BRIEF DESCRIPTION OF DRAWINGS

FIG. 1 is a schematic view showing a combustion system according to a first embodiment.

FIG. 2 is a schematic view showing a combustion system according to a second embodiment.

FIG. 3 is a schematic view showing a combustion system according to a third embodiment.

FIG. 4 is a schematic view showing a combustion system according to a fourth embodiment.

### DESCRIPTION OF EMBODIMENTS

Embodiments of the present disclosure will be described in detail below with reference to the accompanying drawings. Specific dimensions, materials, and numerical values described in the embodiment are merely examples for a better understanding, and do not limit the present disclosure unless otherwise specified. In this specification and the drawings, duplicate explanations are omitted for elements having substantially the same functions and configurations by assigning the same sign. Furthermore, elements not directly related to the present disclosure are omitted from the figures.

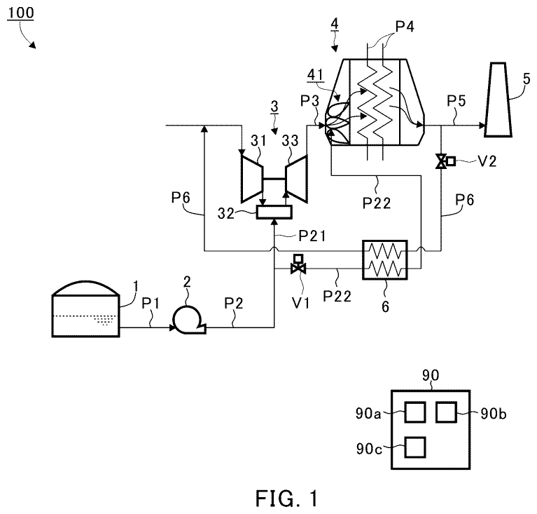

FIG. 1 is a schematic view showing a combustion system 100 according to a first embodiment. In the present embodiment, the combustion system 100 is applied to a system including a gas turbine 3. The combustion system 100 is not limited thereto, and may be applied to another system including a combustor that can use ammonia as at least a part of fuel. For example, in another embodiment, the combustion system 100 may be applied to a system including a boiler that combusts ammonia, and a steam turbine operated by steam generated in the boiler.

For example, in the present embodiment, the combustion system 100 includes a tank (ammonia supply source) 1, a pressurizer 2, the gas turbine 3, an HRSG (heat recovery steam generator) (heat utilization equipment) 4, an exhaust tower 5, a first heat exchanger 6, and a controller 90. The combustion system 100 may further include other components. Furthermore, the combustion system 100 may not include at least one of the above-mentioned components.

The tank 1 stores ammonia. Specifically, the tank 1 stores liquid ammonia. The tank 1 is connected to the pressurizer 2 by piping P1. The liquid ammonia stored in the tank 1 is supplied to the pressurizer 2 through the piping P1. The ammonia supply source is not limited to the tank 1, and may be, for example, other component such as an ammonia producing device.

The pressurizer 2 pressurizes the liquid ammonia supplied from the tank 1. For example, the pressurizer 2 may be a pump. The pressurizer 2 may communicatively be connected to the controller 90 by wire or wirelessly, and may be controlled by the controller 90. For example, the controller 90 controls the output of the pressurizer 2 to adjust the flow rate of ammonia supplied from the tank 1. The pressurizer 2 is connected to piping P2. The piping P2 branches out into piping P21 and piping P22.

The piping P21 is connected to the gas turbine 3. For example, the pressurizer 2 supplies the liquid ammonia to the gas turbine 3 through the piping P21. In another embodiment, the combustion system 100 may include a vaporizer (not shown) on the piping P21, and vaporized ammonia may be supplied to the gas turbine 3.

The piping P22 is connected to a reheating burner 41 (described later). For example, a valve V1 may be arranged on the piping P22. The valve V1 may communicatively be connected to the controller 90 by wire or wirelessly, and may be controlled by the controller 90. For example, the controller 90 controls the output of the pressurizer 2 and the opening degree of the valve V1 to adjust the flow rate of ammonia supplied to the gas turbine 3 and the flow rate of ammonia supplied to the reheating burner 41.

The gas turbine 3 includes a compressor 31, a combustor 32, and a turbine 33.

The compressor 31 compresses air, and supplies the compressed air to the combustor 32. The compressed air is used for combustion in the combustor 32.

The combustor 32 combusts ammonia supplied from the tank 1. Furthermore, the combustor 32 may combust mixed fuel of ammonia and other fuel such as natural gas, or may combust only other fuel, depending on situations. The exhaust gas generated in the combustor 32 is supplied to the turbine 33 and used for operation such as power generation.

The turbine 33 is connected to piping P3. The piping P3 is connected to the HRSG 4. The exhaust gas used in the turbine 33 is supplied to the HRSG 4 through the piping P3.

In the present embodiment, the HRSG 4 is provided as the heat utilization equipment that utilizes heat of the exhaust gas. The heat utilization equipment is not limited thereto. For example, other equipment such as a heating furnace may be used as the heat utilization equipment. The HRSG 4 includes one pipe P4 or a plurality of pipes P4 through which water passes. The HRSG 4 heats and turns water into stream by the heat of the exhaust gas. For example, the steam may be used for operation of the steam turbine (not shown).

The reheating burner 41 is arranged upstream of the piping P4 in the HRSG 4, or arranged upstream of the HRSG 4. The reheating burner 41 combusts ammonia supplied from the tank 1 (described later). Furthermore, the reheating burner 41 may combust mixed fuel of ammonia and other fuel such as natural gas, or may combust only other fuel, depending on situations. For example, the reheating burner 41 heats the exhaust gas when the temperature of the exhaust gas is not high enough to heat and turn water into steam in the HRSG 4. For example, the reheating burner 41 may communicatively be connected to the controller 90 by wire or wirelessly, and may be controlled by the controller 90. For example, the controller 90 controls the heating power of the reheating burner 41 to adjust the temperature of the exhaust gas.

The HRSG 4 is connected to the exhaust tower 5 by piping P5. The exhaust gas used in the HRSG 4 is sent to the exhaust tower 5 through the piping P5, and is released from the exhaust tower 5.

Piping (re-circulation flow path) P6 branches from the piping P5. The piping P6 is connected to an intake flow path of the compressor 31. Accordingly, the piping P6 supplies a part of the exhaust gas used in the HRSG 4 to the combustor 32 via the compressor 31. The compressor 31 compresses mixed gas of air and exhaust gas, and supplies the compressed mixed gas to the combustor 32.

For example, a valve V2 may be arranged on the piping P6. The valve V2 may communicatively be connected to the controller 90 by wire or wirelessly, and may be controlled by the controller 90. For example, the controller 90 controls the opening degree of the valve V2 to adjust the flow rate of the exhaust gas supplied to the compressor 31 through the piping P6.

The first heat exchanger 6 is arranged on the piping P22 and the piping P6. The first heat exchanger 6 exchanges heat between the exhaust gas flowing through the piping P6 and the ammonia flowing through the piping P22. In the present embodiment, the first heat exchanger 6 is of a counter-current flow type in which the exhaust gas and the ammonia flow in directions opposite to each other. In another embodiment, the first heat exchanger 6 may be of a co-current flow type in which the exhaust gas and the ammonia flow in the same direction.

In the first heat exchanger 6, the liquid ammonia flowing through the piping P22 is heated and vaporized by the exhaust gas flowing through the piping P6. Accordingly, the first heat exchanger 6 supplies gas ammonia to the reheating burner 41 through the piping P22. The reheating burner 41 combusts the supplied gas ammonia. Gas ammonia has flammability superior to that of liquid ammonia. Accordingly, with such a configuration, the combustion efficiency in the reheating burner 41 can be improved.

In contrast, in the first heat exchanger 6, the exhaust gas flowing through the piping P6 is cooled by the liquid ammonia flowing through the piping P22. Accordingly, the first heat exchanger 6 supplies the cooled exhaust gas to the compressor 31 through the piping P6. When the temperature of the compressed fluid is reduced, the compressor 31 can be operated with lower power. Accordingly, with such a configuration, the engine efficiency can be improved.

Furthermore, a conversion NOx value used for regulation is expressed by Expression (1) given below.

Conversion NOx value=NOx concentration measurement value×(atmospheric oxygen concentration−conversion reference oxygen concentration)/(atmospheric oxygen concentration−oxygen concentration measurement value) (1)

The mixed gas used in combustion in the combustor 32 includes the exhaust gas supplied by the piping P6. The oxygen concentration in the exhaust gas is lower than the oxygen concentration in atmosphere. Accordingly, in this case, the “oxygen concentration measurement value” in Expression (1) described above is reduced, and hence the conversion NOx value can be reduced even when the “NOx concentration measurement value” does not change.

In particular, in the present embodiment, the exhaust gas supplied from the combustor 32 is further combusted by the reheating burner 41. Accordingly, the oxygen concentration in the exhaust gas supplied to the combustor 32 through the piping P6 is further reduced by the reheating burner 41. Thus, the conversion NOx value can be further reduced.

The controller 90 controls the whole or a part of the combustion system 100. The controller 90 includes, for example, components such as a processor 90a, a memory 90b, and a connector 90c, and those components are connected to each other via buses. For example, the processor 90a includes a central processing unit (CPU) or the like. For example, the memory 90b includes a hard disk, a ROM in which programs or the like are stored, a RAM serving as a work area, and the like. The controller 90 is communicatively connected to each component of the combustion system 100 via the connector 90c by wire or wirelessly. For example, the controller 90 may further include other components such as a display such as a liquid crystal display or a touch panel, and an input device such as a keyboard, a button, or a touch panel. For example, the operations of the controller 90 described above may be implemented by the processor 90a executing programs stored in the memory 90b.

The combustion system 100 as described above includes the combustor 32, the reheating burner 41 that is in fluid communication with the combustor 32 and that heats the exhaust gas supplied from the combustor 32, the HRSG 4 that is in fluid communication with the reheating burner 41 and that uses the heat of the exhaust gas, the piping P6 that supplies a part of the exhaust gas used in the HRSG 4 to the combustor 32, and the first heat exchanger 6 arranged on the piping P6. The first heat exchanger 6 exchanges heat between the exhaust gas and ammonia, and supplies vaporized ammonia to the reheating burner 41 and supplies cooled exhaust gas to the combustor 32. With such a configuration, the gas ammonia is supplied to the reheating burner 41. As described above, gas ammonia has flammability superior to that of liquid ammonia. Accordingly, when the reheating burner 41 uses ammonia as fuel, the combustion efficiency in the reheating burner 41 can be improved. Furthermore, with such a configuration, the cooled exhaust gas is supplied to the compressor 31. As described above, when the temperature of the compressed fluid is reduced, the compressor 31 can be operated with lower power. Accordingly, the engine efficiency can be improved. Moreover, with the above-mentioned configuration, the gas used in combustion in the combustor 32 includes the exhaust gas supplied by the piping P6. The oxygen concentration in the exhaust gas is lower than the oxygen concentration in atmosphere. Accordingly, in this case, the conversion NOx value can be reduced as described above. In particular, in the combustion system 100, the exhaust gas supplied from the combustor 32 is further combusted by the reheating burner 41. Thus, the oxygen concentration in the exhaust gas supplied to the combustor 32 is further reduced by the reheating burner 41. Accordingly, the conversion NOx value can be further reduced.

Next, a system according to another embodiment will be described.

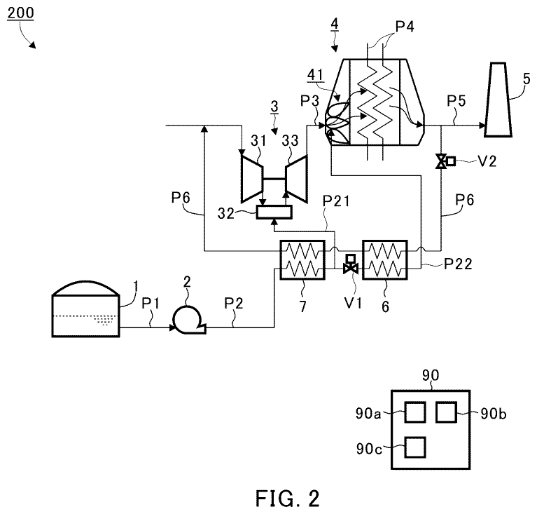

FIG. 2 is a schematic view showing a combustion system 200 according to a second embodiment. The combustion system 200 is different from the above-described combustion system 100 according to the first embodiment in that the combustion system 200 includes a second heat exchanger 7. For other configurations, the combustion system 200 may be the same as the combustion system 100 according to the first embodiment.

The second heat exchanger 7 is arranged on the piping P2 and the piping P6. In the present embodiment, the piping P2 branches out into the above-described piping P21 and the piping P22 at a position downstream of the second heat exchanger 7.

In the present embodiment, the second heat exchanger 7 is arranged upstream of the first heat exchanger 6 in the flow of ammonia in the piping P2. From another perspective, in the present embodiment, the second heat exchanger 7 is arranged downstream of the first heat exchanger 6 in the flow of exhaust gas in the piping P6. The second heat exchanger 7 exchanges heat between the exhaust gas flowing through the piping P6 and the liquid ammonia flowing through the piping P2. In the present embodiment, the second heat exchanger 7 is of a counter-current flow type in which the exhaust gas and the liquid ammonia flow in directions opposite to each other. In another embodiment, the second heat exchanger 7 may be of a co-current flow type in which the exhaust gas and the liquid ammonia flow in the same direction.

In the second heat exchanger 7, the liquid ammonia flowing through the piping P2 is heated by the exhaust gas flowing through the piping P6. In the second heat exchanger 7, the heated liquid ammonia may be kept in the liquid state or may be vaporized.

The second heat exchanger 7 supplies the heated liquid ammonia or the vaporized ammonia to the first heat exchanger 6 through the piping P22. The first heat exchanger 6 further heats the ammonia supplied from the second heat exchanger 7. As described above, the first heat exchanger 6 supplies the vaporized ammonia to the reheating burner 41 through the piping P22. With such a configuration, the combustion efficiency in the reheating burner 41 can be further improved.

Furthermore, the second heat exchanger 7 supplies the heated liquid ammonia or the vaporized ammonia to the combustor 32 through the piping P21. With such a configuration, the combustion efficiency in the combustor 32 can be improved.

In contrast, the exhaust gas flowing through the piping P6 is cooled by the ammonia flowing through the piping P22 in the first heat exchanger 6 as described above, and is further cooled by the ammonia flowing through the piping P2 in the second heat exchanger 7. The second heat exchanger 7 supplies the cooled exhaust gas to the compressor 31 through the piping P6. With such a configuration, the engine efficiency can be further improved.

The combustion system 200 as described above may provide similar effects to those of the combustion system 100 according to the first embodiment. Furthermore, the combustion system 200 further includes the second heat exchanger 7 arranged on the piping P6, wherein the second heat exchanger 7 exchanges heat between the exhaust gas and liquid ammonia, and supplies a part of heated ammonia to the combustor 32 and supplies remaining part of the heated ammonia to the first heat exchanger 6. The first heat exchanger 6 exchanges heat between the exhaust gas and the heated ammonia supplied from the second heat exchanger 7. With such a configuration, the second heat exchanger 7 supplies the heated liquid ammonia or the vaporized ammonia to the combustor 32. Accordingly, when the combustor 32 uses ammonia as fuel, the combustion efficiency in the combustor 32 can be improved.

Furthermore, in the combustion system 200, the second heat exchanger 7 may supply the part of heated ammonia in a liquid state to the combustor 32. With such a configuration, the ammonia is kept in the liquid state from the tank 1 to the combustor 32. Accordingly, a system of supplying ammonia from the tank 1 to the combustor 32 can be simplified. In particular, the amount of ammonia used in the combustor 32 is larger than the amount of ammonia used in the reheating burner 41. Accordingly, the system of supplying ammonia can be more greatly simplified.

Furthermore, in the combustion system 200, the second heat exchanger 7 may supply the part of heated ammonia in a gas state to the combustor 32. As described above, gas ammonia has flammability superior to that of liquid ammonia. Accordingly, with such a configuration, the combustion efficiency in the combustor 32 can be further improved.

Next, a system according to still another embodiment will be described.

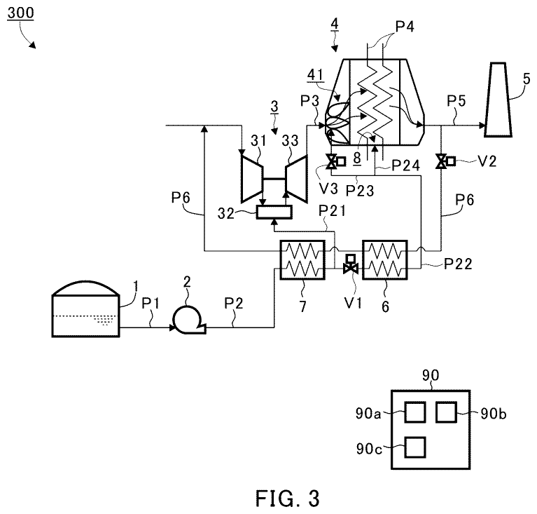

FIG. 3 is a schematic view showing a combustion system 300 according to a third embodiment. The combustion system 300 is different from the above-described combustion system 200 according to the second embodiment in that the first heat exchanger 6 also supplies ammonia to a denitrification equipment 8. For other configurations, the combustion system 300 may be the same as the combustion system 200 according to the second embodiment.

In the present embodiment, the denitrification equipment 8 is arranged in the HRSG 4. For example, the denitrification equipment 8 includes an injector that injects ammonia to the exhaust gas flowing through the HRSG 4. For example, the denitrification equipment 8 may communicatively be connected to the controller 90 by wire or wirelessly, and may be controlled by the controller 90. The piping P22 branches out into piping P23 and piping P24 at a position downstream of the first heat exchanger 6 in the flow of ammonia. The piping P23 is connected to the reheating burner 41. The piping P24 is connected to the denitrification equipment 8.

For example, a valve V3 may be arranged on the piping P23. The valve V3 may communicatively be connected to the controller 90 by wire or wirelessly, and may be controlled by the controller 90. For example, the controller 90 controls the opening degrees of the valve V1 and the valve V3 to adjust the flow rate of ammonia supplied to the reheating burner 41 and the flow rate of ammonia supplied to the denitrification equipment 8.

The combustion system 300 as described above may provide similar effects to those of the combustion system 200 according to the second embodiment. The combustion system 300 further includes the denitrification equipment 8 that reduces a nitrogen oxide in the exhaust gas, and the first heat exchanger 6 supplies a part of vaporized ammonia to the denitrification equipment 8. With such a configuration, the ammonia supplied to the denitrification equipment 8 can be vaporized by the heat of the exhaust gas. Accordingly, the energy efficiency of the combustion system 300 can be improved.

Next, a system according to yet still another embodiment will be described.

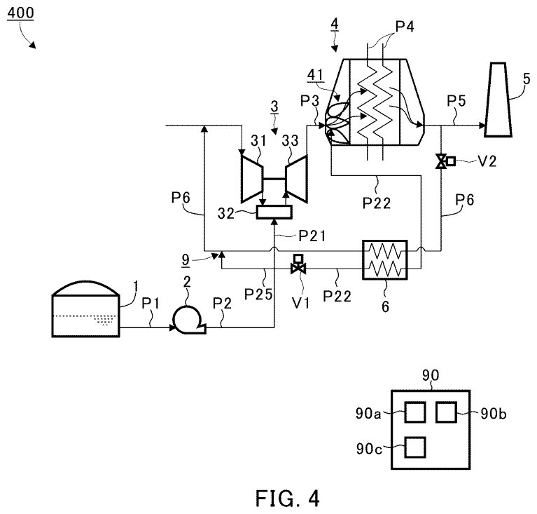

FIG. 4 is a schematic view showing a combustion system 400 according to a fourth embodiment. The combustion system 400 is different from the above-described combustion system 100 according to the first embodiment in that the combustion system 400 includes an injector 9 that directly injects ammonia to the exhaust gas flowing through the piping P6. For other configurations, the combustion system 400 may be the same as the combustion system 100 according to the first embodiment.

For example, the injector 9 is arranged downstream of the first heat exchanger 6 in the flow of exhaust gas in the piping P6. In the present embodiment, the piping P2 branches out into the above-mentioned piping P21 and piping P22, and piping P25. The piping P25 is connected to the injector 9. For example, the injector 9 may communicatively be connected to the controller 90 by wire or wirelessly, and may be controlled by the controller 90. The ammonia directly injected to the exhaust gas is combusted in the combustor 32.

The combustion system 400 as described above may provide similar effects to those of the combustion system 100 according to the first embodiment. Furthermore, the combustion system 400 includes the injector 9 that directly injects liquid ammonia to the exhaust gas flowing through the piping P6. With such a configuration, the exhaust gas supplied to the compressor 31 can be further cooled by the liquid ammonia directly injected to the exhaust gas. Accordingly, the engine efficiency can be further improved. Furthermore, the injected ammonia is supplied to the gas turbine 3, and hence is not wasted.

Although the embodiments of the present disclosure have been described above with reference to the accompanying drawings, the present disclosure is not limited thereto. It is obvious that a person skilled in the art can conceive of various examples of variations or modifications within the scope of the claims, which are also understood to belong to the technical scope of the present disclosure.

For example, the injector 9 in the fourth embodiment may be provided in each of the combustion system 200 according to the second embodiment and the combustion system 300 according to the third embodiment. In this case, for example, the piping P25 may branch from the piping P2 at a position upstream of the second heat exchanger 7 in the flow of ammonia in the piping P2.

The present disclosure can promote the use of ammonia to reduce CO₂ emissions, thus contributing to Sustainable Development Goals (SDGs), Goal 7 “Ensure access to affordable, reliable, sustainable and modern energy,” for example.

What is claimed is:

1. A combustion system using ammonia as fuel, the combustion system comprising:
a combustor;
a reheating burner that is in fluid communication with the combustor and that heats exhaust gas supplied from the combustor;
heat utilization equipment that is in fluid communication with the reheating burner and that uses heat of the exhaust gas;
a re-circulation flow path that supplies a part of the exhaust gas used in the heat utilization equipment to the combustor; and
a first heat exchanger arranged on the re-circulation flow path, the first heat exchanger exchanging heat between the exhaust gas and ammonia, the first heat exchanger supplying vaporized ammonia to the reheating burner and supplying cooled exhaust gas to the combustor.

2. The combustion system according to claim 1, further comprising a second heat exchanger arranged on the re-circulation flow path, the second heat exchanger exchanging heat between the exhaust gas and liquid ammonia, the second heat exchanger supplying a part of heated ammonia to the combustor and supplying remaining part of the heated ammonia to the first heat exchanger,
wherein the first heat exchanger exchanges heat between the exhaust gas and the heated ammonia supplied from the second heat exchanger.

3. The combustion system according to claim 2, wherein the second heat exchanger supplies the part of the heated ammonia in a liquid state to the combustor.

4. The combustion system according to claim 2, wherein the second heat exchanger supplies the part of the heated ammonia in a gas state to the combustor.

5. The combustion system according to claim 1, further comprising an injector that directly injects liquid ammonia to the exhaust gas flowing through the re-circulation flow path.

6. The combustion system according to claim 1, further comprising a denitrification equipment that reduces a nitrogen oxide in the exhaust gas,
wherein the first heat exchanger supplies a part of the vaporized ammonia to the denitrification equipment.
